(19) United States
(12) Patent Application Publication
(10) Pub. No.: US 2013/0014119 A1
(43) Pub. Date: Jan. 10, 2013

(54) Resource Allocation Prioritization Based on Knowledge of User Intent and Process Independence

(75) Inventor: Noah Tilman Rowles, Los Angeles, CA (US)

(73) Assignee: Iolo Technologies, LLC, Los Angeles, CA (US)

(21) Appl. No.: 13/178,444

(22) Filed: Jul. 7, 2011

(51) Int. Cl. G06F 9/50

(52) U.S. Cl. 718/104

(57) ABSTRACT

A method and system to improve performance of a computer system is disclosed. One aspect of certain embodiments includes selectively deallocating or allocating computer resources to a set of computer programs associated with the computer system.

### TECHNICAL FIELD

The disclosed embodiments relate generally to computer systems. More particularly, the disclosed embodiments relate to methods and systems to improve the performance of computer systems.

### BACKGROUND

With the advance of service-oriented-architecture in software development, most computer software now breaks a logical program into multiple processes, each with their own process priority and resource allocation. The relationship between these processes may not be known to the operating system. The current state of the art in operating systems is to implement these as multiple processes. Most logical programs are dependent on multiple operating processes. Because of this complex set of interdependence, modern operating systems generally implement “greatest common denominator” algorithms that ensure the maximum number of processes is allocated RAM and CPU resources. These algorithms attempt to minimize the time taken to switch between multitasking applications. However, this optimization inherently limits the ability of the operating system to allocate resources to maximize performance of a specific logical program and the multiple processes it requires for proper functioning. These algorithms frequently lead to brief periods of time during which user-focus programs may get no CPU allocation, resulting in interruptions to input output. This can be particularly apparent in processor intensive multimedia applications, such as audiovisual, playback or computer games. Thus, a better method is needed to allocate computer resources among the computer program processes that are running in a computer system at a given time.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram describing manual and automatic triggers for allocation or deallocation of computer resources, according to certain embodiments of the invention.

FIG. 2 is a high-level flow chart that describes the selection process for allocation or deallocation of computer resources, according to certain embodiments of the invention.

FIG. 3 is a high-level flow chart that describes the triggering of allocation and deallocation of computer program processes, according to certain embodiments of the invention.

FIG. 4 is a high-level diagram describing an overview of the deallocation process, according to certain embodiments of the invention.

FIG. 5 is a high-level diagram describing an overview of the allocation process, according to certain embodiments of the invention.

### DESCRIPTION OF EMBODIMENTS

Methods, systems, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments of the invention, the performance of a computer system can be managed by deallocating or allocating computer resources to a set of computer programs. According to one aspect of the embodiment, a user can arbitrarily select the computer programs for which computer resources are to be deallocated or allocated.

According to certain embodiments, deallocation of computer resources can mean any of the following:

1) Lowering the selected computer program's process priority in relation to the process priority of other computer programs in the computer system; or
2) Terminating the selected computer program from execution and memory.

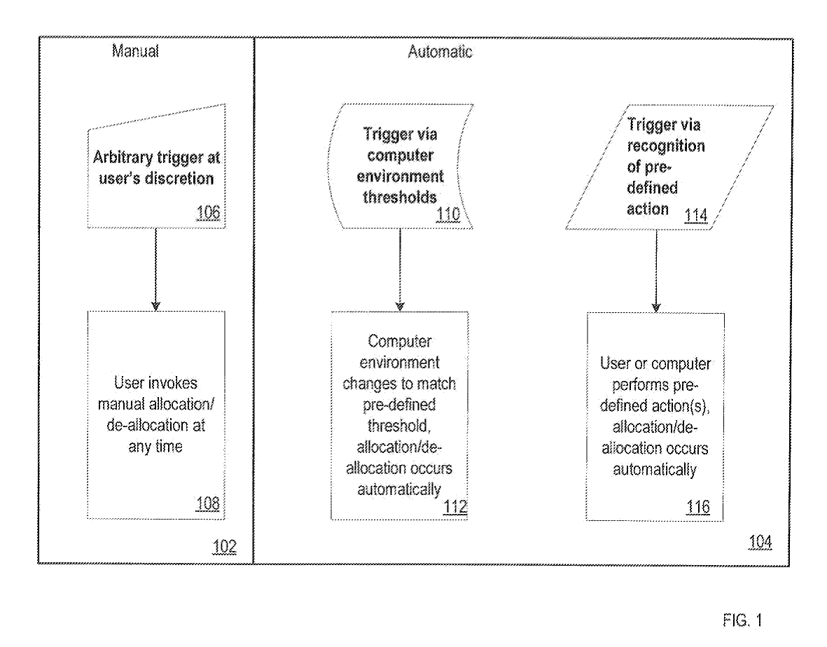

According to certain embodiments, the allocation or deallocation of computer resources can be triggered manually or automatically. FIG. 1 is a block diagram describing manual and automatic triggers for allocation or deallocation of computer resources. In FIG. 1, block 102 describes a non-limiting example of a manual trigger, according to certain embodiments of the invention. In the case of a manual trigger, block 106 describes that an arbitrary trigger can be invoked at the user's discretion. For example, as described in block 108, the user can invoke a manual allocation or deallocation of computer resources to certain computer programs running on the computer system at any time through a software user interface. In FIG. 1, block 104 generally describes non-limiting examples of automatic triggers. Block 110 describes that triggers can be automatically invoked when certain computer environment thresholds are met. For example, block 112 describes that allocation or deallocation of computer resources can automatically occur when the computer environment matches pre-defined conditions. Block 114 describes that triggers can be automatically invoked when a pre-defined action is recognized by the computer system. For example, block 116 describes that allocation or deallocation of computer resources can automatically occur when a user performs one or more pre-defined actions or when the computer system performs one or more pre-defined actions.

According to certain embodiments, some non-limiting examples of automatic triggers include:
Network usage, throughput, capacity, or availability exceeds or falls below certain pre-defined thresholds, where the network usage, throughput, capacity and availability can be measured at a given instant of time or over a pre-defined period of time.
Memory usage, throughput, capacity, or availability exceeds or falls below certain pre-defined thresholds, where the memory usage, throughput, capacity and availability can be measured at a given instant of time or over a pre-defined period of time.
Storage device usage, throughput, capacity, or availability exceeds or falls below certain pre-defined thresholds, where the storage device usage, throughput, capacity and availability can be measured at a given instant of time or over a pre-defined period of time.
The usage, throughput, capacity, or availability of one or more other computer resources exceeds or falls below pre-defined thresholds, where the usage, throughput, capacity and availability can be measured at a given instant of time or over a pre-defined period of time.
One or more specific programs are executed or terminated.
Computer resources specific to one or more programs exceed or fall below certain pre-defined thresholds.
One or more specific pre-defined actions are performed on the computer system by the user and/or by the computer system.
On a pre-defined one-time or recurring schedule.

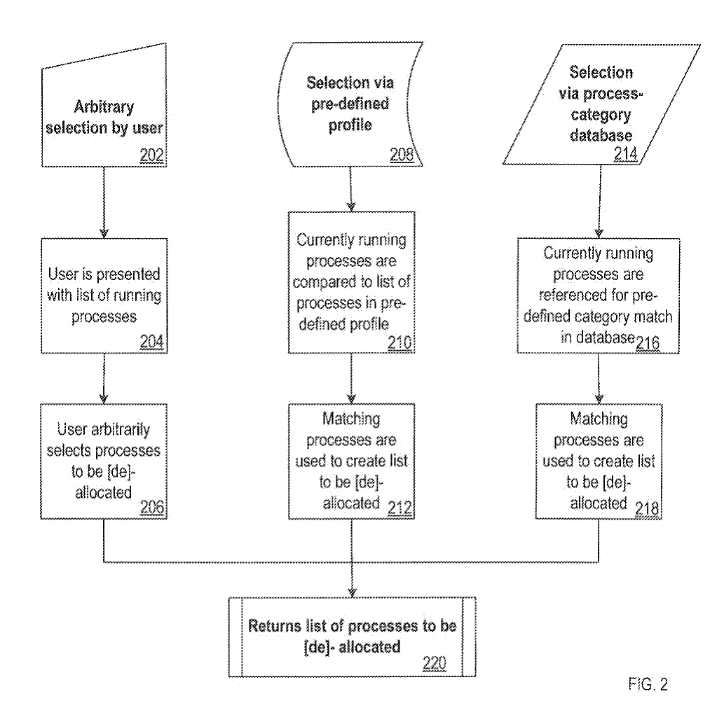

FIG. 2 is a high-level flow chart that describes the selection process for allocation or deallocation of computer resources, according to certain embodiments. For example, the selection process can be an arbitrary selection by a user of the computer system, as shown in block 202. At block 204, the user is presented with a list of computer program processes that are running. At block 206, the user arbitrarily selects from the list presented at block 204, computer program processes for allocation or deallocation of computer resources. At block 220, the list of computer program processes for which computer resources are to be allocated or deallocated is returned. FIG. 2 also describes that the selection process can be made through a pre-defined profile, as shown in block 208. At block 210, the computer program processes that are currently running are compared to the list of computer program processes in the pre-defined profile. At block 212, currently running computer program processes that match computer program processes identified in the pre-defined profile are used to create the list of computer programs for which computer resources are to be allocated or deallocated. FIG. 2 also describes that the selection process can be made using a pre-defined process-category database, as shown in block 214. At block 216, the computer program processes that are currently running are referenced for pre-defined category matching using the process-category database. At block 218, currently running computer program processes that match pre-defined categories are used to create the list of computer programs for which computer resources are to be allocated or deallocated.

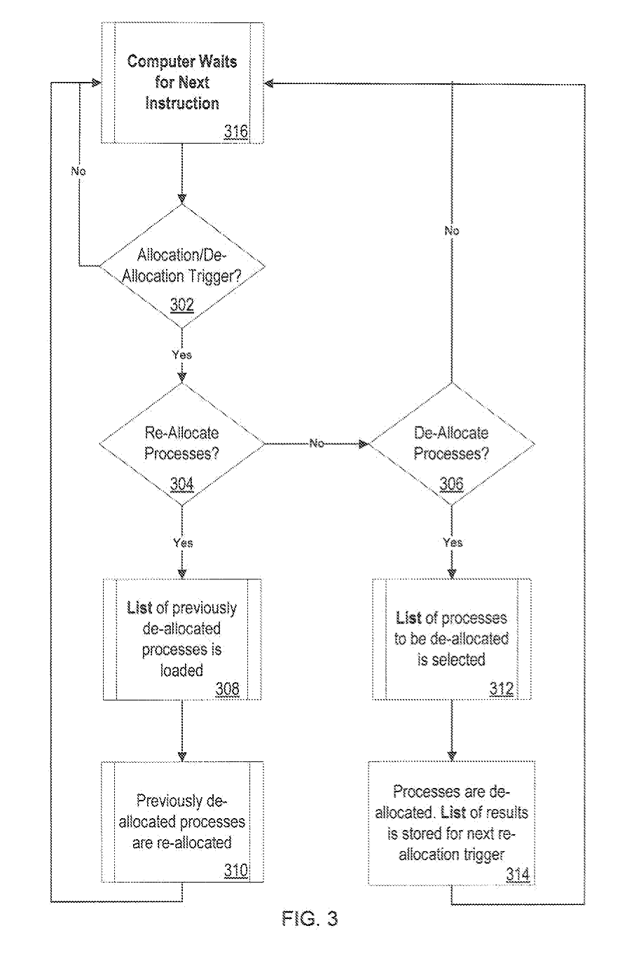

FIG. 3 is a high-level flow chart that describes the triggering of allocation and deallocation of computer program processes, according to certain embodiments. At block 302, the computer system determines if there is an allocation or deallocation trigger. At block 304, it is determined if computer programs for which computer resources were previously deallocated are to be reallocated the computer resources. If it is determined that the computer programs for which computer resources were previously deallocated are to be reallocated the computer resources, then at block 308, the list of computer programs for which computer resources were previously deallocated is loaded. At block 310, the computer programs for which computer resources were previously deallocated are reallocated with computer resources. At block 316, the computer system waits for the next instruction.

If it is determined at block 304 that there is to be no reallocation of computer resources, then at block 306, it is determined if there are computer program processes to be deallocated of computer resources. If there are computer program processes for which computer resources are to be deallocated, then at block 312, the list of computer program processes are selected for deallocation of computer resources. At block 314, the list of selected computer program processes are deallocated of computer resources and this list of selected computer program processes is stored for use with the next re-allocation trigger.

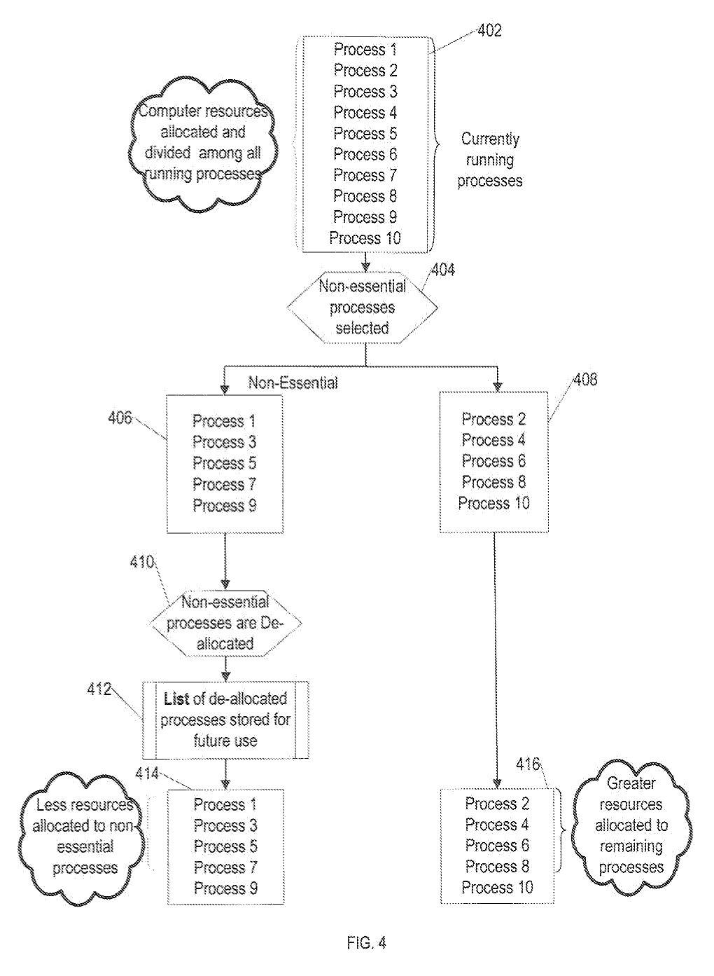

FIG. 4 is a high-level diagram describing an overview of the deallocation process, according to certain embodiments of the invention. Block 402 shows currently running computer program processes in the computer system. The available computer resources are allocated among the currently running computer program processes. At block 404, from the list of currently running computer program processes non-essential computer program processes are selected for deallocation of computer resources. Block 406 shows the selected list of non-essential computer program processes while block 408 shows the remaining computer program processes from the list of currently running computer program processes. At block 410 the non-essential computer program processes are deallocated of computer resources. At block of 412, the list of computer program processes that are deallocated of computer resources is stored for future use. Block 414 shows the list of computer program processes that are deallocated of computer resources. An example of deallocation of computer resources is the allocation of less computer resources to the computer program processes selected block 406 relative to the computer resources of the computer program processes shown in block 416. Block 416 shows the list of computer program processes that are allocated more computer resources relative to the computer resources of the computer program processes shown in block 414.

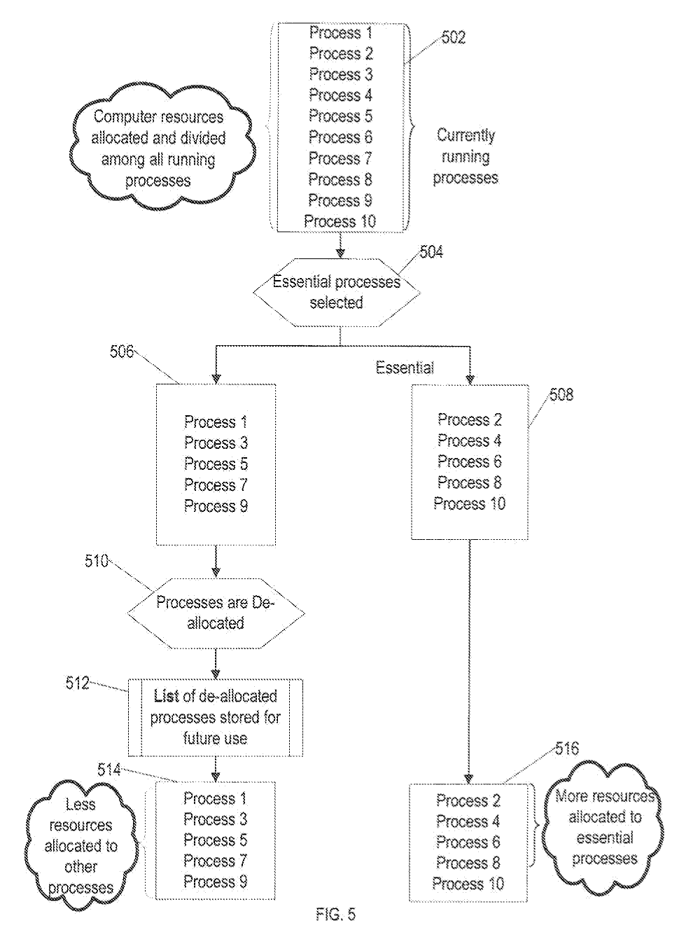

FIG. 5 is a high-level diagram describing an overview of the allocation process, according to certain embodiments of the invention. Block 502 shows currently running computer program processes in the computer system. The available computer resources are allocated among the currently running computer program processes. At block 504, from the list of currently running computer program processes essential computer program processes are selected. Block 508 shows the selected list of essential computer program processes while block 506 shows the remaining computer program processes from the list of currently running computer program processes. At block 510 the computer program processes from block 506 are deallocated of computer resources. At block of 512, the list of computer program processes that are deallocated of computer resources is stored for future use. Block 514 shows the list of computer program processes that are deallocated of computer resources. An example of deallocation of computer resources is the allocation of less computer resources to the computer program processes listed in block 506 relative to the computer resources allocated to the computer program processes shown in block 516. Block 516 shows the list of computer program processes that are allocated more computer resources relative to the computer resources of the computer program processes shown in block 514.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A computer-implemented method of managing performance of a computer system, the method comprising:
based on a first set of criteria, deallocating computer resources to a set of computer programs associated with the computer system, wherein the set of computer programs can include arbitrarily selected programs; and
optionally reallocating computer resources to the set of computer programs based on a second set of criteria.

2. The computer-implemented method of claim 1 further comprises:
selecting a list of computer programs for which computer resources are to be deallocated based on the first set of criteria; and
after deallocating computer resources, storing the list of computer programs for which computer resources are deallocated.

3. The computer-implemented method of claim 1, wherein optionally reallocating computer resources further comprises:
based on the second set of criteria, loading a list of computer programs for which computer resources were previously deallocated.

4. The computer-implemented method of claim 1 further comprises:
allowing a user to arbitrarily select computer programs for which computer resources are to be allocated or deallocated.

5. The computer-implemented method of claim 1 further comprises:
allocating or deallocating computer resources to computer programs identified in a pre-created profile list of computer programs.

6. The computer-implemented method of claim 1 further comprises:
allocating or deallocating computer resources to computer programs identified in a pre-defined category of computer programs.

7. The computer-implemented method of claim 5, wherein the pre-created profile list of computer programs is created by a user using a user interface associated with the computer system.

8. The computer-implemented method of claim 5, wherein the pre-created profile list of computer programs is selected by a user from a plurality of pre-created profiles using a user interface associated with the computer system.

9. The computer-implemented method of claim 6, wherein the pre-defined category of computer programs is created by referencing corresponding program categorization data stored in a database.

10. The computer-implemented method of claim 1, wherein the first and second sets of criteria includes one or more manual triggers.

11. The computer-implemented method of claim 1, wherein the first and second sets of criteria includes one or more automatic triggers.

12. The computer-implemented method of claim 10, wherein the manual trigger includes one or more user actions invoking an allocation or deallocation process through a user interface.

13. The computer-implemented method of claim 11, wherein the automatic trigger includes when one or more of network usage, throughput, capacity and availability exceeds or falls below a corresponding pre-defined threshold, wherein the network usage, throughput, capacity and availability can be measured at a given instant of time or over a pre-defined period of time.

14. The computer-implemented method of claim 11, wherein the automatic trigger includes when one or more of memory usage, throughput, capacity and availability exceeds or falls below a corresponding pre-defined threshold, wherein the memory usage, throughput, capacity and availability can be measured at a given instant of time or over a pre-defined period of time.

15. The computer-implemented method of claim 11, wherein the automatic trigger includes when one or more of storage device usage, throughput, capacity and availability exceeds or falls below a corresponding pre-defined threshold, wherein the storage device usage, throughput, capacity and availability can be measured at a given instant of time or over a pre-defined period of time.

16. The computer-implemented method of claim 11, wherein the automatic trigger includes when one or more of usage, throughput, capacity and availability of one or more computer resources exceeds or falls below a corresponding pre-defined threshold, wherein the usage, throughput, capacity and availability can be measured at a given instant of time or over a pre-defined period of time.

17. The computer-implemented method of claim 11, wherein the automatic trigger includes when one or more computer resources associated with a specified computer program exceeds or falls below a corresponding pre-defined threshold, wherein the one or more computer resources can be measured at a given instant of time or over a pre-defined period of time.

18. The computer-implemented method of claim 11, wherein the automatic trigger includes when one or more computer programs are executed.

19. The computer-implemented method of claim 11, wherein the automatic trigger includes when one or more computer programs are terminated.

20. The computer-implemented method of claim 11, wherein the automatic trigger includes when a user performs one or more specified actions on the computer system.

21. The computer-implemented method of claim 11, wherein the automatic trigger includes when the computer system performs one or more specified actions.

22. The computer-implemented method of claim 1 further comprises:
selecting non-essential computer programs for which computer resources are to be deallocated;
allocating lower resources to the non-essential computer programs; and
allocating greater resources to remaining computer programs.

23. The computer-implemented method of claim 1 further comprises:
selecting essential computer programs for which computer resources are to be allocated;
allocating greater resources to the essential computer programs; and
allocating lower resources to remaining computer programs.

24. The computer-implemented method of claim 1, wherein deallocation of resources includes adjusting one or more of: computer program process priority, network priority, I/O priority, memory priority, and CPU priority.

25. The computer-implemented method of claim 24, wherein adjusting includes one or more of:
raising a corresponding priority to a specified degree;
lowering a corresponding priority to a specified degree;
assigning a maximum upper limit to a corresponding priority; and
assigning a maximum lower limit to a corresponding priority.

26. The computer-implemented method of claim 1, wherein deallocation of resources includes adjusting one or more of: data storage capacity and network bandwidth capacity.

27. The computer-implemented method of claim 26, wherein adjusting includes one or more of:
assigning a maximum upper limit to a corresponding capacity; and
assigning a maximum lower limit to a corresponding capacity.

28. The computer-implemented method of claim 1, wherein deallocating resources includes any one of terminating, suspending or delaying execution of one or more computer programs associated with the computer system and wherein allocating or reallocating resources includes initiating or executing one or more computer programs associated with the computer system.
